(19) United States
(12) Patent Application Publication
(10) Pub. No.: US 2015/0116154 A1
(43) Pub. Date: Apr. 30, 2015

(54) LENS ANTENNA WITH ELECTRONIC BEAM STEERING CAPABILITIES

(71) Applicant: LIMITED LIABILITY COMPANY "RADIO GIGABIT", Moscow (RU)

(72) Inventors: Aleksey Andreevich ARTEMENKO, Nizhniy Novgorod (RU); Vladimir Nikolaevich SSORIN, Nizniy Novgorod (RU); Roman Olegovich MASLENNIKOV, Nizhniy Novgorod (RU); Andrey Viktorovich MOZHAROVSKIY, Nizhniy Novgorod (RU)

(73) Assignee: LIMITED LIABILITY COMPANY "RADIO GIGABIT", Moscow (RU)

(21) Appl. No.: 14/593,552

(22) Filed: Jan. 9, 2015

Related U.S. Application Data
(63) Continuation-in-part of application No. PCT/RU2013/000591, filed on Jul. 10, 2013.

(30) Foreign Application Priority Data
Jul. 10, 2012 (RU) 2012128960

(51) Int. Cl. H01Q 3/24; H01Q 13/02

(52) U.S. Cl. CPC H01Q 3/245; H01Q 13/02
USPC 342/371; 342/374

(57) ABSTRACT

The invention discloses a lens antenna with high directivity intended for use in radio-relay communication systems, said antenna providing the capability of electronic steering of the main radiation pattern beam by switching between horn antenna elements placed on a plane focal surface of the lens. Electronic beam steering allows antenna to automatically adjust the beam direction during initial alignment of transmitting and receiving antennas and in case of small antenna orientation changes observed due to the influence of different reasons (wind, vibrations, compression and/or extension of portions of the supporting structures with the temperature changes, etc.). The technical result of the invention is the increase of the antenna directivity with simultaneously provided capability of scanning the beam in a continuous angle range and also the increase of the antenna radiation efficiency and, consequently, the increase of the lens antenna gain. This result is achieved by the implementation of horn antenna elements with optimized geometry.

### CROSS-REFERENCE TO RELATED APPLICATIONS

This application is a continuation-in-part of International application PCT/RU2013/000591 filed on Jul. 10, 2013 which claims priority benefits to Russian patent application RU 2012128960 filed on Jul. 10, 2012. Each of these applications is incorporated herein by reference for all purposes.

### FIELD OF THE INVENTION

The present invention generally relates to radio engineering, more particularly to antenna engineering, and intended for use preferably in high throughput radio-relay point-to-point and point-to-multipoint systems operating primarily in millimeter wave range.

### BACKGROUND ART

Radio-relay systems are used for high throughput point-to-point communications over the distances of several kilometers in line-of-sight conditions. Such systems are widely used in different transport networks for variety of applications one of the most perspective being backhaul networks between base stations of mobile cellular communication systems.

At the present time used are radio-relay systems of different frequency ranges from 10 GHz up to 100 GHz. With the increase of the requirements for high data throughput the use of higher frequency ranges becomes more perspective. The increase of data throughput using higher carrier frequency values is based generally on the possibility of utilization of wider frequency band for signal transmission.

In order to compensate free space propagation losses radio-relay systems utilize aperture antennas, which size is significantly larger than an operating wavelength. Such antennas are characterized by a high directivity value and a narrow main beam of a radiation pattern. Aperture antennas include various reflector antennas, horn-lens antennas, Cassegrain and Gregorian antennas, as well as lens antennas. A feed antenna element of those antennas radiates a signal while a secondary device (mirrors, lens) is of large size and forms a narrow radiation pattern.

However, the use of antennas with a narrow radiation pattern beam involves difficulties related to antenna alignment and probability of connection refuse in case of even small orientation changes of a radio-relay system. In order to provide automatic alignment of the beam direction in a certain continuous angle range (with the width of several main radiation pattern beams) at short time and without the need of special staff service, aperture antennas with electronic beam steering capabilities are introduced.

Although the electronic steerability can be realized in different types of aperture antennas, integrated lens antennas are the most perspective for this purpose. In these antennas primary antenna elements are mounted directly on a plane surface of a dielectric lens, the plane surface is located close to the focal surface of the lens. Scanning is performed by switching between primary antenna elements having different displacements from the lens axis.

Placing the antenna elements on the dielectric lens surface favorably distinguishes integrated lens antennas from other types of lens antennas such as horn-lens antennas, Fresnel lenses, thin lenses (as compared with a focus distance) with separated primary antenna elements.

Placing the antenna elements on the dielectric lens surface leads to decrease of the electrical wavelength when the signal is propagating in the lens body, the decrease is larger for greater values of the lens dielectric permittivity. This helps to achieve miniaturization of the antenna elements themselves and the possibility of placing the antenna elements on small distances from each other. Accordingly, the required antenna array area is significantly lower than for other antenna types in which antenna elements and the main focusing device (a mirror or a lens) are separated from each other.

Further, close arrangement of the antenna elements provides small angle distance between main beam directions during scanning. Thus, it is possible to develop steerable antennas with sufficiently tight beams overlap during scanning and, consequently, to provide steerability in a certain solid angle range, which exceeds the antenna beamwidth. This advantage of integrated lens antennas is especially important for described applications, in particular, for millimeter wave radio-relay communications.

Known are steerable integrated lens antennas, in which primary antenna elements are based on planar structures, such as high frequency printed and ceramic boards, different semiconductor integrated circuits. However it is very difficult to perform optimization of the antenna elements characteristics in those antennas in order to provide the most efficient illumination of the collimating lens surface and, consequently, to achieve maximum directivity. Moreover, losses in a planar structure and/or in electrical connections of integrated circuits are quite high that leads to decrease of the radiation efficiency and the antenna gain value.

Antennas with electronic beamsteering capabilities become more common in various communication applications including different radar applications, local area networks and radio-relay communication systems. Below is the review of the main scanning antennas with a narrow radiation pattern beam commonly used in different applications.

Reflector Scanning Antennas

A reflector antenna with electronic beam scanning may include a dish of any type with separated feeds like a Cassegrain antenna and an array of switched horn antennas performing a function of primary antenna elements. FIG. 1 illustrates the main principle of scanning in such aperture antennas. Beam scanning in different types of reflector antennas (such as parabolic antennas or Cassegrain antennas) is performed mainly either by mechanical shift of a primary antenna element relatively to the focus point of the main reflector, or by electronic switching between several primary elements located in different displacements from the focus point. Antennas with electronic scanning are more promising since they provide the capability of beam alignment with short time without the need of support of specialized staff.

However, some limitations of scanning antenna systems of similar types are also known. They include difficulties in providing of solid angle coverage range during scanning with simultaneous maintenance of high aperture efficiency of antennas (especially with increase of beam deviation angles). Scanning angle range can be considered as continuous if the beams formed by excitation of each of primary antenna elements overlap each other with a certain predefined level (usually a half power level or −3 dB from the radiation pattern maximum). FIG. 2 schematically shows beams of a scanning antenna, which overlap each other at the −3 dB level, i.e. with mutual beams deviations equal to the beam width θ_{3 dB} of the radiation pattern.

As can be seen from FIG. 2, in case of large mutual beams deviations some areas are generated in which a signal level is significantly below the maximum, and thus a scanning range cannot be further considered as continuous. Beams deviations in aperture antennas are determined by displacements of antenna elements with respect to the antenna axis.

Complexity in providing of continuous scanning range in reflector antennas is caused by considerably large dimensions of horn antenna elements (in parabolic reflector antennas) or of secondary hyperbolic mirror (in Cassegrain antennas), which makes it impossible to place their phase centers close to each other and, consequently, to provide a continuous scanning angle range.

As an example, a parabolic antenna with the diameter of 130 mm and the focus distance of 150 mm provides the maximum directivity of 38.1 dBi at the 75 GHz frequency when a horn feed element has the diameter of 8 mm. Accordingly, the minimum geometrically possible displacement of a primary antenna element is about 8.5-9 mm (taking into account some thickness of a horn metal walls), that leads to the beam deviation of 3.3° for the beam width at −3 dB level from the maximum of only 2.0°. In order to decrease the beam deviation to 2.0° it is necessary to use a horn antenna element with a diameter of 4.0 mm (in this case minimum possible displacement is 5.0 mm). However, it leads to degradation of the antenna directivity being only 35.5 dBi due to the increased level of spillover radiation losses.

Described example shows that the beam overlap level in reflector antennas can be increased by decreasing of dimensions of horn antenna elements and, consequently, by closer placement of antenna elements to each other. In this case, some part of the radiation from a feed horn antenna element is propagated beyond the main reflector (due to a wider radiation pattern of an antenna element), and it leads to decrease of the antenna aperture efficiency and, consequently, to decrease of its directivity.

In order to solve the described problem, it was proposed to use horn antenna elements by pairs so that phase centers of radiation patterns formed by exciting of each horn pair are positioned close to each other and required antenna beams overlap is provided. However, as it may be clear for those skilled in the art, the increase of a number of horn antenna elements leads to antenna complexity and high cost of such antenna system.

Further, it is important to mention the requirement of precise positioning of the array of horn antenna elements relative to the focus of the main reflector in the antenna. In order to provide precise mechanical positioning different additional fixing devices are used. However, those devices also increase the antenna complexity.

Scanning Antennas for Automotive Radars

Also another type of aperture antennas with electronic scanning is available which consists of a number of antenna elements to receive a signal and a number of antenna elements to transmit a signal. Selection of a main radiation pattern beam direction is performed by a switching circuit. In order to form a narrow antenna radiation pattern beam either lens antennas or reflector antennas with separated primary antenna elements can be used. An array of antenna elements is fabricated using a dielectric board and placed in a focus of the main reflector or the lens.

The described configuration also has all mentioned drawbacks typical of the antennas with primary antenna elements mounted separately from the main reflector or the lens.

Lens Antennas with Electronic Beam Scanning

A large variety of lens antennas providing high directivity values is known. Correspondingly scanning can be performed in those antennas using different techniques depending on the antenna construction.

The most known are lens antennas of different shapes with separated primary antenna elements.

Similarly to reflector antennas beam scanning in those antennas is performed by displacement of a primary antenna element from the focus point orthogonal to the lens axis. The limitations in such antennas are the same as for reflector antennas described above.

Integrated Lens Antennas with Planar Antenna Elements

Integrated lens antennas are used for development of directional antennas with wide range of achievable characteristics.

Placing the array of antenna elements on the surface of the lens with a proper shape allows to avoid many limitations of other antennas with electronic scanning. These limitations concern the necessity of arrangement of switched primary antenna elements on some curved surface, more often spherical surface, the necessity of precise alignment of the array of primary antenna elements in a focal plane of the main collimating device, difficulties in providing of continuous scanning angle range and high directivity of the antenna.

According to one known configuration of integrated lens antennas an integrated lens antenna comprises planar feed elements placed on a lens with multilayer cylindrical extension (see FIG. 3). Such antenna configuration allows using slot and spiral antenna elements that increases directivity of the integrated lens antenna. Moreover, it is shown that directivity maximization can be performed by changing the length of a cylindrical extension of the hemispherical lens. However it should be noted that this optimization technique can be effectively applied only when the lens dimensions are not large (less than 10-20 of operational wavelength in diameter). With further increase of the lens diameter this technique become less effective because variations of the cylindrical extension length lead to significant distortions of a plane wave front formed by the lens. Thus, a critical task is maximization of directivity of the lens antenna with a large aperture by parameters optimization of only the primary antenna element located on a surface of canonical elliptical lens with cylindrical extension.

According to another known configuration of an integrated lens antenna primary antenna elements are fabricated using a semiconductor integrated circuit (see FIG. 4). In such antenna structure it is also difficult to provide directivity maximization by variations of only planar antenna elements parameters that is needed when the lens diameter is large. Moreover, implementation of antenna elements on a semiconductor substrate with relatively high loss level leads to small radiation efficiency that decreases the gain.

According to one more configuration of an integrated lens antenna it has a function of electronic beam steering, and said antenna comprises a dielectric lens with a planar surface, antenna elements, and a switching circuit applying a signal to at least one of the antenna elements.

In this antenna structure primary antenna elements can be made using a dielectric board (e.g., printed circuit or ceramic board), which can be fabricated in large quantity by standard widely used technologies. Utilization of the dielectric board allows increasing radiation efficiency of the lens antenna relatively to the considered case when antenna elements are made using a semiconductor integrated circuit. Some examples of known integrated lens antennas configurations with planar antenna elements are shown in FIG. 5. A switching circuit and a transceiver chip in the described antenna structure are mounted on the same dielectric board using high frequency connection techniques.

The main drawback of such configuration lies in having difficulties with optimization of primary antenna elements structure for the directivity maximization in the lens antennas with large apertures.

Thus, the object of the present invention is to provide a lens antenna with electronic beam steering in a continuous angle range which provides both high directivity and radiation efficiency values.

### SUMMARY OF THE INVENTION

According with the invention a lens antenna providing electronic beam steering is comprised of a dielectric lens having a plane surface, antenna elements, and a switching system applying a signal to at least one of the antenna elements, characterized in that the antenna elements are horn antenna elements having metallic structure, wherein the antenna elements are mounted on the plane surface of the dielectric lens such that said elements radiate into the dielectric lens.

Making of antenna elements as horn antenna elements placed on the plane surface of the dielectric lens results in increase of the directivity value and provides at the same time continuous scanning angle range in contrast to the known antennas.

Furthermore, the lens antenna used for example in radio communications according to the described invention has increased radiation efficiency keeping continuous scanning angle range and, consequently, increased gain relatively to the known lens antennas with planar feed elements that also provide continuous scanning angle range.

In particular, utilization of horn antenna elements placed on the plane surface of the dielectric lens allows increasing the antenna directivity in comparison to the known integrated lens antennas by selecting geometric parameters of antenna elements (a shape and dimensions of a horn). Horn antenna elements have metallic structure with low conducting losses that additionally provides high radiation efficiency and, consequently, a high gain value in such antennas.

Utilization of integrated lens antennas according to the present invention having switched horn antenna elements placed on the plane surface of the dielectric lens, also allows to eliminate the limitation of the known reflector antennas, in particular, it helps to increase antenna aperture efficiency and, consequently, directivity by optimization of the horn parameters having continuous scanning angle range through closer arrangement of horns on the plane lens surface that is possible by using shortened wavelength for a signal propagating inside the lens body (consequently, horn dimensions are also decreased). Furthermore, positioning of the horns relatively to the lens focus is simplified in the lens antenna by placing the horns directly on the lens surface.

For comparison with the considered formerly characteristics of a reflector antenna, simulation results for an integrated lens antenna with the same diameter (130 mm) with a circular horn antenna element with diameter of 2.5 mm at 75 GHz frequency are presented below. A lens from the material with the dielectric permittivity of 2.1 is considered, that provides equality of lateral dimensions of the lens and the parabolic antennas (150 mm) for more accurate comparison. In the described case the integrated lens antenna provides the directivity of 38.0 dBi and beam deviation of 2° (that corresponds to the beam width at −3 dB level) by horn antenna element displacement of about 3 mm. Thus, the use of the lens antennas according to the present invention allow increasing directivity on 2.5 dB in comparison with a parabolic antenna of the same dimensions providing continuous scanning angle range.

According to one embodiment of the present invention, the proposed antenna comprises a transceiver realized with the ability to transmit a signal via one of antenna elements and to receive a signal from one of antenna elements, said transceiver electrically connected to the switching circuit.

According to another embodiment of the present invention, signal transmission and reception are performed in different frequency bands.

According to yet another embodiment of the present invention antenna also comprises a switch for switching between transmit/receive modes.

In a preferred embodiment the switching system comprises at least one switch of 1×N type (N≧2), where N is a number of output switch channels, and said at least one switch is realized on semiconductor chips. In that embodiment semiconductor chips are mounted on the dielectric substrate with the use of high frequency electrical connections. As an alternative high frequency connection can be implemented as wire bond or flip-chip connections. In addition, the switching circuit mounted on a dielectric substrate can be electrically connected to the antenna elements and to the transceiver by waveguide-to-microstrip transitions.

According to yet another embodiment of the present invention, antenna elements at least partially filled with dielectric material. In that embodiment, dielectric material of horn antenna elements can be selected so, that its dielectric permittivity lies in the range from approximately 1 to the value of the lens dielectric permittivity.

In yet another embodiment of the present invention the plane surface of the lens is substantially coincide with the lens focal plane.

According to yet another embodiment of the present invention, horn antenna elements have a rectangular section. As an alternative, horn antenna elements can have circular section.

According to yet another embodiment of the present invention a shape of the dielectric lens is selected from a group comprising a shape of hemi-ellipsoid of revolution with a cylindrical extension and a shape of hemisphere with a cylindrical extension. As an alternative the cylindrical extension of the lens can be truncated by a cone with a vertex lying on the lens axis out of the lens body.

According to yet another embodiment of the present invention antenna have a gain greater than 30 dBi.

According to yet another embodiment of the present invention antenna elements dimensions are determined so to provide maximized directivity, and distances between the antenna elements are chosen so to provide continuous scanning angle range of the disclosed antenna.

According to yet another embodiment of the present invention, horn antenna elements are realized with the ability to be fed by a waveguide.

As an alternative, antenna can operate in the 71-86 GHz frequency band and provide the half power beam width less than 1° for each beam forming during scanning. Alternatively, antenna can operate in the 57-66 GHz frequency band and provide the half power beam width less than 3° for each beam forming during scanning.

According to yet another embodiment of the present invention, antenna provides high throughput communication in millimeter wave radio-relay system and allows electronic adjustment of the main beam during initial antenna alignment or in case of appearing antenna orientation changes.

Also disclosed is a system for millimeter wave high throughput radio-relay point-to-point or point-to-multipoint communication comprising a lens antenna according to any embodiments of the present invention.

Different aspects and features of the present invention can be understood from the description of the preferred embodiments and from the enclosed figures.

### BRIEF DESCRIPTION OF THE DRAWINGS

FIG. 1 schematically shows a reflector antenna with electronic beam scanning (prior art).

FIG. 2 shows antenna beams formed during scanning and overlapped at −3 dB level from the maximum.

FIG. 3 shows an integrated lens antenna with a planar antenna element and optimized length of the cylindrical extension (prior art).

FIG. 4 shows an integrated lens antenna with antenna elements realized on a semiconductor chip (prior art).

FIG. 5 shows an integrated lens antenna with antenna elements realized on a dielectric board (prior art).

FIG. 6 shows a lens antenna according to the present invention with an array of horn antenna elements.

FIG. 7 schematically shows the effects of spillover radiation and losses associated with the lens illumination for two cases: a) relatively wide and b) relatively narrow radiation pattern of the antenna element.

FIG. 8 presents directivity of the horn antenna element without dielectric filling (a) and with dielectric filling (b) when it radiates into the lens body having dielectric permittivity of 2.1 at 75 GHz frequency.

FIG. 9 illustrates a structure of the lens antenna according to the present invention.

FIG. 10 shows a structure of the lens antenna according to the present invention with a transceiver and a planar substrate for semiconductor switch mounting connected to each other and to horn antenna elements using a waveguide-to-microstrip transition.

FIG. 11 shows an integrated lens antenna according to the present invention with horn antenna elements partially filled with dielectric material.

FIG. 12 shows elliptical or hemispherical lenses with cylindrical and truncated cone extensions according to the present invention.

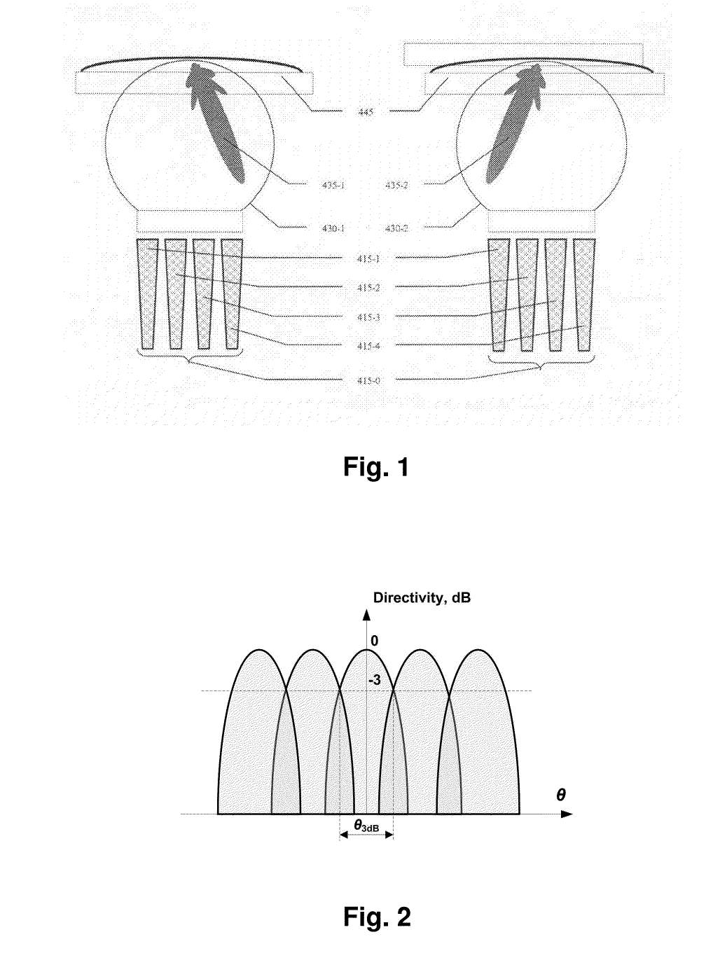

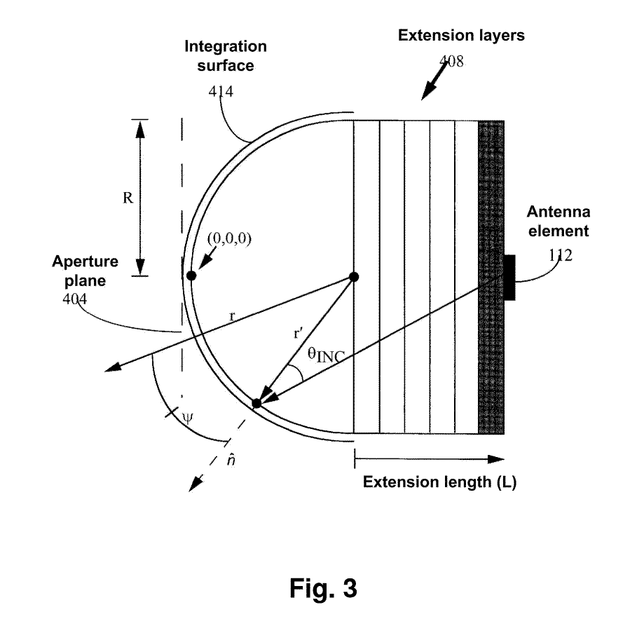

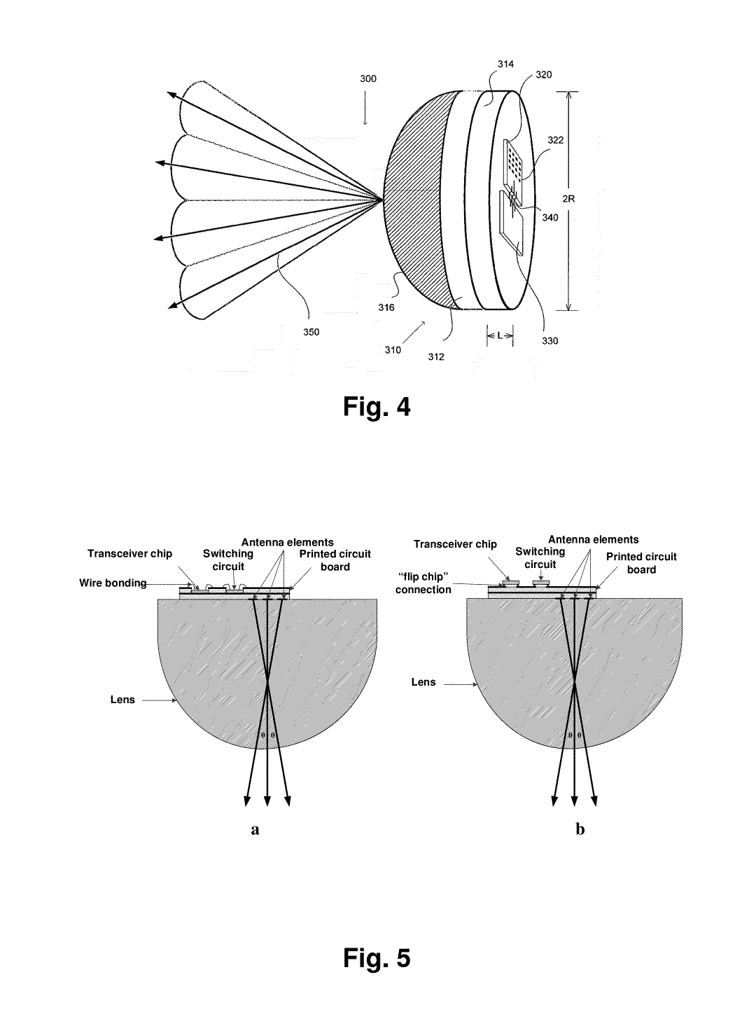

### DETAILED DESCRIPTION OF THE INVENTION

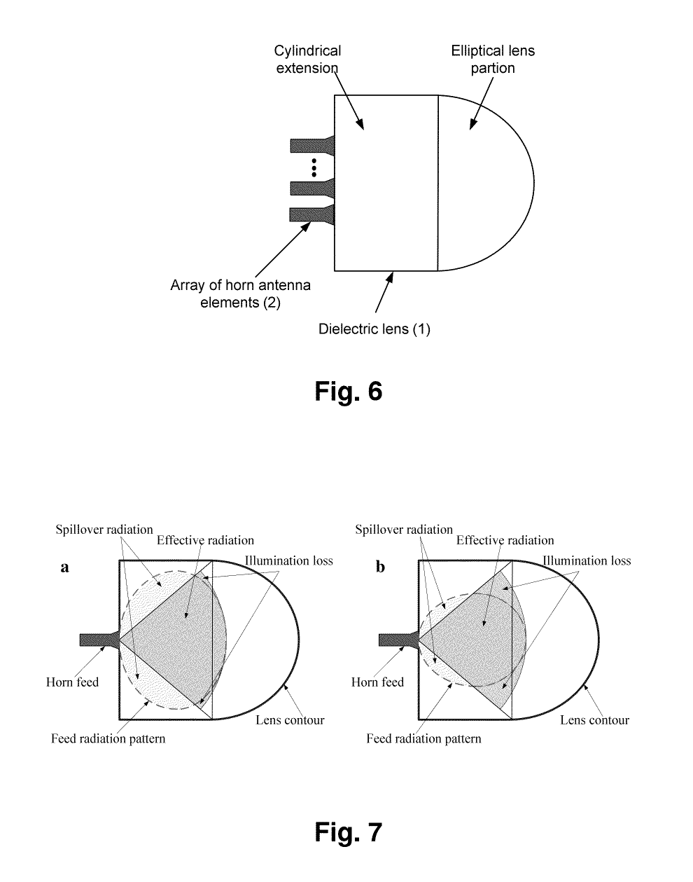

To achieve the described objects of characteristics optimization of integrated lens antennas with large dimensions (diameter is >10-20 times of wavelength in free space) it is proposed to use horn feed antenna elements in such antennas that are placed on the plane surface of the lens as it is shown in FIG. 6.

The preferred shape of the large lens providing all the required antenna characteristics for use in radio-relay communication systems is elliptical shape made of homogeneous dielectric with certain dielectric permittivity.

Variation of the lens geometrical parameters (either of elliptical part or the length of cylindrical extension) cannot be used for optimization of the antenna characteristics due to phase front degradations aroused on the equivalent aperture of the antenna. However, such optimization is possible by variations of the primary antenna element radiation characteristics that lead to increase in directivity of an integrated lens antenna. In particular, for wide radiation pattern of the primary antenna element inside the lens body the effect of spillover radiation from the side cylindrical surface of the lens becomes important. This radiation leads to increase of side lobes levels of the lens antenna radiation pattern and, consequently, to decrease of its directivity. Conversely, when the radiation pattern of the primary antenna element inside the lens body is quite narrow than localization of the radiation intensity on the central part of the elliptical lens surface is observed that leads to decrease of the antenna aperture efficiency. Herewith radiation pattern of the lens antenna has wider main beam and lower directivity. Schematically both described effects are illustrated in FIG. 7a and FIG. 7b. Adjustment of the antenna element characteristics allow determining the optimal balance between spillover radiation level and losses associated with the illumination of the lens elliptical surface. It provides maximization of the lens antenna directivity.

In case planar primary antenna elements are used the optimization of their radiation characteristics are quite complicated and requires utilization of complex solutions and techniques, for example, adding of parasitic radiation elements, thickening of a substrate structure, development of a radiators comprised of several simultaneously radiating antenna elements. Moreover, all the considered techniques are significantly limited on the range of possible resulting characteristics of the radiation pattern of planar antenna elements inside the lens body. It is also important to note that during design of beam steerable lens antennas with a planar array it is also necessary to take into account electromagnetic isolation between the antenna elements that does not allow placing the antenna elements close to each other. All the described above objects lead to the complex lens antenna structure and to increase of fabrication costs.

Another possibility disclosed in the present invention is utilization of horn antenna elements. Optimization of its radiation pattern characteristics can be performed simply by variations of dimensions of the horn cross-section. Herewith, since in that case horn antenna elements are mounted on the surface of the lens with certain dielectric permittivity than a range of the optimized characteristics (in particular, the width of the radiation pattern) is quite large. In addition, the use of horn antenna elements provides high isolation level between the neighboring antenna elements even in its close disposition. It is a property of horn antenna elements provided by its enclosed metallic structure from all the sides. Horn antenna elements can be fabricated, for example, from aluminum or brass; its faces, moreover, can be additionally plated by thin film of silver or gold.

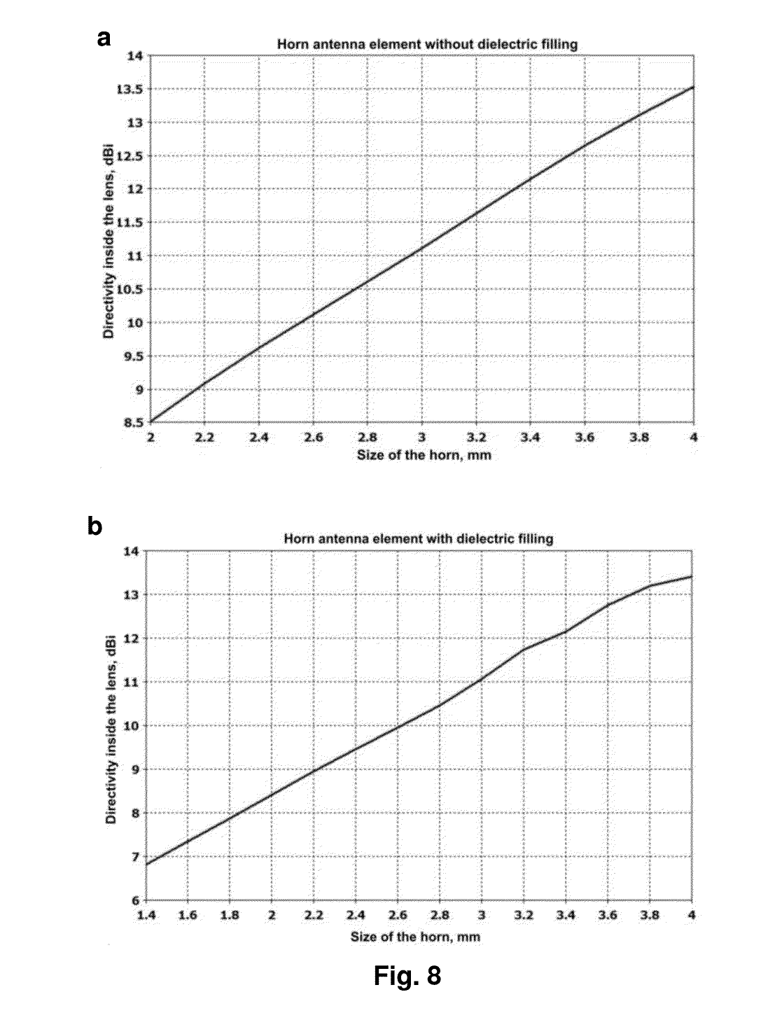

As an example FIG. 8a shows a directivity curve of a horn antenna with square section of different size when it radiates into the lens with dielectric permittivity of 2.1 at 75 GHz frequency. It can be seen from the presented results that variations of the horn antenna element cross-section dimensions change directivity of its radiation pattern inside the lens body from 8.5 dBi to more than 13 dBi. These directivity variations in the indicated range lead to different balance between the spillover radiation from the cylindrical lens surface and illumination losses of the elliptical lens surface. As a result it reveals the possibility of improvement of the whole lens antenna characteristics, more particular, to increase directivity of the lens antenna providing at the same time continuous scanning angle range.

It is also important to note that for better impedance matching the horn antenna element can be partially or entirely filled with dielectric with permittivity close to the lens dielectric permittivity. This filling can be realized using different materials, for example, polytetrafluoroethylene (dielectric permittivity is 2.1) when the lens is made of polytetrafluoroethylene or rexolite (dielectric permittivity is 2.53). In that case, even larger range of variations of horn antenna element directivity can be provided. It can be achieved by the effect of electrical wavelength shrinkage in the horn with dielectric filling structure. FIG. 8b shows directivity of a horn antenna element with square section and with dielectric filling for different lengths of the horn cross-section in each dimension when it radiated into a half space with dielectric permittivity of 2.1 at 75 GHz frequency. It can be seen that different directivities in the range from 7 dBi to more than 13 dBi can be provided. In contrast, practical values of different planar antenna elements directivities for the same lens material are not greater than 8.5 dBi that is often makes impossible to provide optimal performance. This conclusion is valid also for the lenses made of other materials with other dielectric permittivity values, for example, quartz (dielectric permittivity is 3.8).

It can be noted that by the considered variation of the horn antenna element the directivity of the whole integrated lens antenna can be increased on 1-3 dB. For example, for the lens with 200 mm diameter made of dielectric with permittivity of 2.1 and fed by a dielectric filled horn antenna element with a cross-section of 1.5×1.5 mm² directivity of such a lens antenna is 40.4 dBi. In contrast when a horn with 2.8×2.8 mm² cross-section is used than the lens directivity increases to 42.1 dBi.

The disclosed integrated lens antenna configuration also makes it possible to place the antenna elements close to each other that provides beams overlap during scanning at some certain level (for example, −3 dB from maximum) and, consequently, provides continuous angle range in which antenna adaptation can be performed to establish radio connection. That possibility is determined by the electrical wavelength shrinkage that is proportional to the refraction index of the lens material and, consequently, by the decrease of required cross-section dimensions of a horn antenna element in comparison with similar antenna elements used in the known reflector or lens antennas with separated feeds.

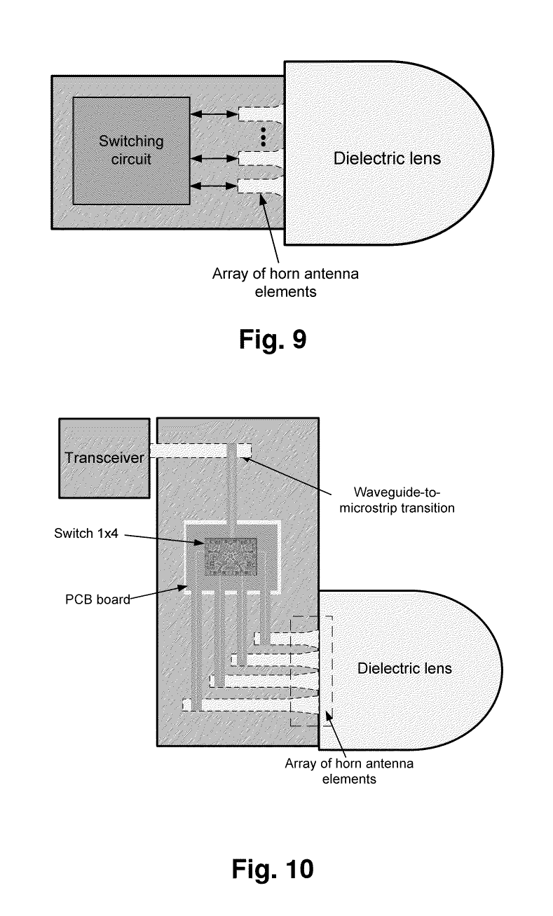

Accordingly, in one of the most preferred embodiment the disclosed integrated lens antenna with electronic beam scanning includes a dielectric lens with a plane surface, antenna elements, and a switching circuit applying a signal to at least one antenna element, and differs from prior art in that the antenna elements represent horn antenna elements placed on the plane surface of the dielectric lens and radiate into the lens. A general structure of the lens antenna according to the present invention is shown in FIG. 9. The plane surface is substantially coincide with the lens focal plane, antenna elements dimensions provide maximum directivity, and distances between the antenna elements provide continuous scanning angle range of the antenna.

In the described configuration the switching circuit is used for selection and feeding a signal to one of the horn antenna elements. The selected antenna element placed on the plane surface of the lens radiates a signal with substantially spherical phase front into the lens body. The lens is used for transformation of that spherical wave front in a plane wave front in free space outside the lens that determines high directivity and narrow beam of the resulted radiation pattern of the antenna in far zone. Herewith the plane wave front and, consequently, narrow antenna beam in far zone are formed in a direction defined by a distance between the center of the plane lens surface and selected antenna element in the array.

Integrated lens antenna according to the present invention effectively realizes all their advantages including those for large lenses with dimensions 10s times greater than a wavelength on the operation frequency. Thus, at 60 GHz frequency a lens with 100 mm diameter provides a half power beamwidth of 3°, and a lens with 150 mm diameter—2°. Directivities of these lenses are 33 dBi and 36.5 dBi correspondingly. The lenses can be fabricated, for example, from polytetrafluoroethylene. Then the lens lateral dimension will be 117 mm and 175 mm for the considered diameters. Continuous scanning angle range in this case is provided for the distance between neighboring antenna elements in the array equal to 2.8 mm.

In another embodiment of the present invention the antenna additionally includes a transceiver transmitting a signal via one of the antenna elements and receiving a signal from one of the antenna elements and electrically connected to the switching circuit. Herewith signal transmission and reception are performed either simultaneously in different frequency bands (frequency division duplexing mode) or in different time slots in one band (time division duplexing mode). In the later case, the antenna can additionally comprise a switch for timing between transmission and reception regimes. This switch can be realized either separately from the antenna switching circuit or integrally with this switching circuit.

The switching circuit can be based on one or several semiconductor integrated circuits mounted on a dielectric board using high frequency electrical connections, for example, wire bonding or flip-chip. In that embodiment a lens antenna also includes waveguide-to-microstrip transitions for electrical connection of the switching circuit with primary antenna elements and with the transceiver. These transitions provide signal delivery from the transceiver to a planar transmission line, which feed an input port of the switching circuit and further from selected by the switching circuit output planar transmission line to a horn antenna element with a waveguide feed. The structure of this embodiment of the invention is shown in FIG. 10.

Horn antenna elements with different cross-section shapes can be used in the described invention. In particular, the most practical antenna elements can be realized by widening of standard rectangular waveguides. In that case a cross-section of a horn antenna element also has a rectangular shape. In another embodiment, horn antenna elements with circular cross-section can be implemented to provide symmetrical (relatively to the lateral axis) antenna element radiation pattern inside the lens body.

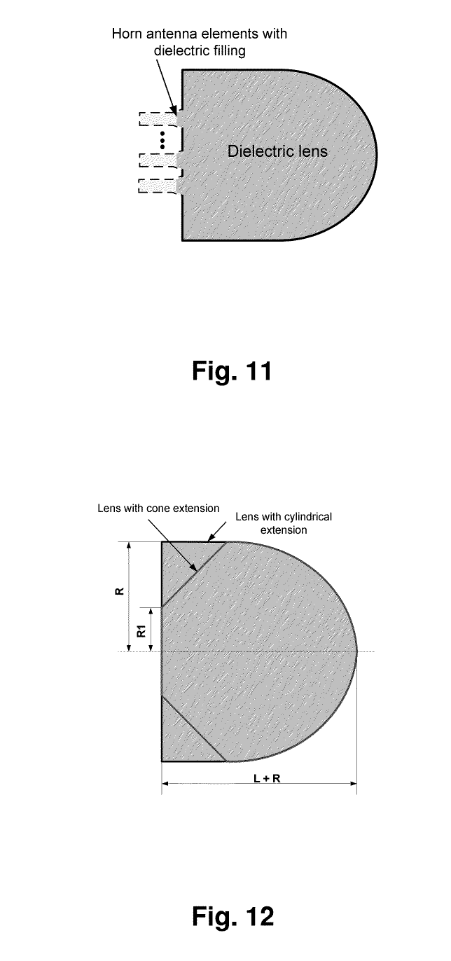

In one another embodiment, partially dielectric filling of horn antenna elements is realized by protrusions having a certain shape made technologically on the plane lens surface in positions where antenna elements are mounted. A shape of these protrusions is determined so to provide the most effective impedance matching (minimum reflection coefficient). An integrated lens antenna according to the present invention with horn antenna elements partially filled with dielectric is shown in FIG. 11.

In the described invention a shape of the dielectric lens is selected from a group comprising a shape of hemi-ellipsoid of revolution with a cylindrical extension, a hemispherical shape with a cylindrical extension, a shape of hemi-ellipsoid of revolution with a truncated cone extension, a hemispherical shape with a truncated cone extension. FIG. 12 shows a dielectric lens with a shape of hemi-ellipsoid with cylindrical and truncated cone extensions. Usage of lenses with a truncated cone extension allows decreasing significantly the lens weight that is very important for large antennas intended for use in point-to-point millimeter wave systems.

The lens antenna according to the present invention can provide a gain of more than 30 dBi in different frequency bands. However the most perspective is implementation of that antenna providing a half power beam width of the radiation pattern of 1° for point-to-point communications in the 71-86 GHz frequency range or providing a half power beam width of 3° in the 60 GHz frequency range.

The lens antenna according to any of the described embodiments can provide high throughput communication in millimeter wave point-to-point and point-to-multipoint radio-relay systems and to adjust the main antenna beam direction during initial antenna alignment procedure or in case of changes of antenna orientation due to external reasons such as wind, vibration, compression and/or extension of portions of the supporting structures with the temperature changes, etc.

The present invention is not limited to specific embodiments described in the present disclosure by way of example only; the invention encompasses all modifications and variations without departing from the spirit and scope of the invention set forth in the accompanying claims.

1. A lens antenna providing electronic beam scanning, the antenna comprising: a) a homogeneous dielectric lens having a collimating surface from one side and a plane surface from another side, b) antenna elements, and c) a switching circuit applying a signal to at least one of the antenna elements, characterized in that the antenna elements are hollow horn antenna elements made or covered by metal, and the antenna elements are mounted on the plane surface of the dielectric lens such that said antenna elements radiate into the dielectric lens.

2. The antenna according to claim 1, further comprising a transceiver operating in a transmission mode to transmit signals to at least one of the antenna elements and operating in a reception mode to receive signals from at least one of the antenna elements, wherein the transceiver is electrically connected to the switching circuit.

3. The antenna according to claim 2, wherein the signals are transmitted and received in different non-overlapping frequency bands.

4. The antenna according to claim 2, further comprising a switch for switching between the transmission mode and the reception mode.

5. The antenna according to claim 1, wherein the switching circuit includes at least one switch of 1×N type (N≧2), where N is a quantity of output channels in the switch, wherein the at least one switch is based on semiconductor integrated circuits.

6. The antenna according to claim 5, wherein the semiconductor integrated circuits forming the switching circuit are mounted on a dielectric board using high frequency electrical connections.

7. The antenna according to claim 6, wherein one of the high frequency electrical connections is a wire bonding.

8. The antenna according to claim 6, wherein one of the high frequency electrical connections is a flip-chip connection.

9. The antenna according to claim 6, wherein the switching circuit mounted on the dielectric board is electrically connected to the antenna elements and to the transceiver by means of waveguide-to-microstrip transitions.

10. The antenna according to claim 1, wherein the horn antenna elements are at least partially filled with a dielectric material.

11. The antenna according to claim 10, wherein the dielectric material is selected so that its dielectric permittivity is in the range from approximately 1 to approximately the value of dielectric permittivity of the lens.

12. The antenna according to claim 1, wherein the plane surface of the lens substantially coincide with the focal plane of the lens.

13. The antenna according to claim 1, wherein each of the horn antenna elements has a cross-section selected from a group of cross-sections including rectangular and circular.

14. The antenna according to claim 1, wherein a shape of the dielectric lens is selected from a group including a hemi-ellipsoid of revolution with a cylindrical extension and a hemisphere with a cylindrical extension.

15. The antenna according to claim 15, wherein the cylindrical extension of the lens is truncated by a cone with a vertex lying outside the lens on its axis.

16. The antenna according to claim 1, wherein dimensions of the antenna elements are selected so as to provide an optimized directivity; and distances between the antenna elements are selected so as to provide continuous scanning angle range of the antenna.

17. The antenna according to claim 1, wherein the horn antenna elements are fed using a waveguide.

18. The antenna according to claim 1, operating in the frequency range of 71-86 GHz and providing a half power beamwidth lower than 1° for each beam during scanning.

19. The antenna according to claim 1, operating in the frequency range of 57-66 GHz and providing a half power beamwidth lower than 3° for each beam during scanning.

20. The antenna according to claim 1, providing high throughput communication in millimeter wave point-to-point or point-to-multipoint radio-relay system and adjusting the main antenna beam during initial antenna alignment procedure or in case of changes of antenna orientation.
